(19) United States
(12) Patent Application Publication
(10) Pub. No.: US 2003/0090600 A1
(43) Pub. Date: May 15, 2003

(54) Embedded light shield scheme for micro display backplane fabrication

(75) Inventors: Xavier Seah Teo Leng, Singapore (SG); Chivukula Subrahmanyam, Singapore (SG)

Correspondence Address: WAGNER, MURABITO & HAO LLP, Third Floor, Two North Market Street, San Jose, CA, 95113, US

(73) Assignee: CHARTERED SEMICONDUCTORS MANUFACTURED LIMITED

(21) Appl. No.: 10/012,289

(22) Filed: Nov. 13, 2001

(51) Int. Cl. G02F 1/136

(52) U.S. Cl. 349/43

(57) ABSTRACT

A light shield apparatus and formation method for preventing the transmission of incident light towards active devices of the display. In one embodiment, the present invention recites patterning a second metal layer to form a plurality of second metal structures. The present embodiment also recites depositing an intermetal dielectric layer above the plurality of second metal structures. Subsequently, the present embodiment deposits a light absorbing antireflective coating material above the intermetal dielectric layer to form a light shield followed by another planarized IMD layer such that transmission of incident light towards underlying active devices is reduced. The present embodiment also performs the step of forming a plurality of metal pixels above the antireflective coating material wherein adjacent ones of the plurality of metal pixels have a gap region disposed therebetween. As a result, the antireflective coating material of the present embodiment reduces the transmission of incident light through the gap region between the plurality of metal pixels and towards the active devices of the display.

### FIELD OF THE INVENTION

The present claimed invention relates to the field of display device technology. More particularly, the present claimed invention relates to a display device formation method and apparatus for reducing ambient light penetration into a display device.

### BACKGROUND ART

Liquid crystal display devices (LCDs) are well known in the art. In particular, microdisplays are the finest panel displays which offer low power, high resolution and greater functional integration. Common to many microdisplay concepts is the use of CMOS (complementary metal oxide silicon) backplane upon which a light modulating layer is placed. Typically in microdisplays, the topmost level fabricated on the bottom substrate (sometimes referred to as the “backplane”) is an array of metal pixels which are coupled to underlying transistors. A layer of liquid crystal material is disposed over the metal pixels. By selectively controlling the underlying transistors, an electric field can be generated at the array of metal pixels. This electric field, in turn, causes the liquid crystal material to selectively allow for the transmission of light therethrough. In so doing, the display is controlled to produce an image. For a microdisplay based on liquid crystal on silicon (LCOS) technology, the backplane is subjected to strong incident light in order to project a produced image onto a focal plane.

Unfortunately, subjecting a LCOS microdisplay to strong incident light can have deleterious consequences. Specifically, such strong incident light poses a potential threat to device operation due to photoelectron generation and interference. That is, in some conventional displays incident light can penetrate through the upper portion of the backplane and affect the operation of underlying active devices.

Thus, a need exists for a display device formation method and apparatus which reduces the penetration of incident light into the backplane.

### SUMMARY OF INVENTION

The present invention provides a display device formation method and apparatus which reduces the penetration of incident light into the backplane.

In one embodiment, the present invention recites patterning a second metal layer to form a plurality of second metal structures. The present embodiment also recites depositing an intermetal dielectric layer above the plurality of second metal structures followed by chemical mechanical polishing (CMP). Subsequently, the present embodiment deposits a light absorbing antireflective coating material (ARC) above the planarized intermetal dielectric layer to form a light shield followed by another planarized IMD layer such that transmission of incident light towards underlying active devices is reduced. The present embodiment also performs the step of forming a plurality of metal pixels above the antireflective coating material wherein adjacent ones of the plurality of metal pixels have a gap region disposed therebetween. As a result, the antireflective coating material of the present embodiment reduces the transmission of incident light through the gap region between the plurality of metal pixels and towards the active devices of the display.

In another embodiment, the present invention includes the features of the above-described embodiment, and further recites patterning the layer of the antireflective coating material such that a plurality of regions of the antireflective coating material are formed above the intermetal dielectric layer. In one embodiment, at least one of the plurality of regions of the antireflective coating material is disposed underlying the gap region between the adjacent ones of the plurality of metal pixels. In so doing, incident light passing through the gap region is prevented, by the at least one of the plurality of regions of the antireflective coating material, from passing unimpeded towards the underlying active devices.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

FIG. 1 is a side sectional view of a portion of a CMOS backplane of a liquid crystal on silicon (LCOS) microdisplay formed according to conventional methods.

FIG. 2A is a side sectional view of a portion of a CMOS backplane of a microdisplay device having metal structures (Ti/TiN/AlCu/ARC) formed thereon in accordance with one embodiment of the present claimed invention.

FIG. 2B is a side sectional view of the structure of FIG. 2A having an intermetal dielectric layer disposed thereover in accordance with one embodiment of the present claimed invention.

FIG. 2C is a side sectional view of the structure of FIG. 2B having the intermetal dielectric layer planarized in accordance with one embodiment of the present claimed invention.

FIG. 2D is a side sectional view of the structure of FIG. 2C having a light absorbing antireflective coating material deposited thereover in accordance with one embodiment of the present claimed invention.

FIG. 2E is a side sectional view of the structure of FIG. 2D having a layer of photosensitive material disposed thereover in accordance with one embodiment of the present claimed invention.

FIG. 2F is a side sectional view of the structure of FIG. 2E wherein the layer of photosensitive material has been patterned in accordance with one embodiment of the present claimed invention.

FIG. 2G is a side sectional view of the structure of FIG. 2F wherein the antireflective coating material has been patterned in accordance with one embodiment of the present claimed invention.

FIG. 2H is a side sectional view of the structure of FIG. 2G wherein the remaining portions of the layer of photosensitive material have been removed in accordance with one embodiment of the present claimed invention.

FIG. 2I is a side sectional view of the structure of FIG. 2H having an intermetal dielectric layer deposited and planarized thereover in accordance with one embodiment of the present claimed invention.

FIG. 2J is a side sectional view of the structure of FIG. 2I having a layer of photosensitive material disposed thereover in accordance with one embodiment of the present claimed invention.

FIG. 2K is a side sectional view of the structure of FIG. 2J wherein the layer of photosensitive material has been patterned in accordance with one embodiment of the present claimed invention.

FIG. 2L is a side sectional view of the structure of FIG. 2K having vias formed therein in accordance with one embodiment of the present claimed invention.

FIG. 2M is a side sectional view of the structure of FIG. 2L wherein the remaining portions of the layer of photosensitive material have been removed in accordance with one embodiment of the present claimed invention.

FIG. 2N is a side sectional view of the structure of FIG. 2M having a layer of barrier metal (e.g. Ti/TiN) followed by a conductive material (W) disposed thereover and in the vias in accordance with one embodiment of the present claimed invention.

FIG. 2O is a side sectional view of the structure of FIG. 2N wherein the layer of conductive material has been planarized or etched back to form (W) plug in accordance with one embodiment of the present claimed invention.

FIG. 2P is a side sectional view of the structure of FIG. 2O having a top metal pixel layer (comprised of Ti/TiN/AlCu/TEOS hardmask) disposed thereover in accordance with one embodiment of the present claimed invention.

FIG. 2Q is a side sectional view of the structure of FIG. 2P having a layer of photosensitive material disposed thereover in accordance with one embodiment of the present claimed invention.

FIG. 2R is a side sectional view of the structure of FIG. 2Q wherein the layer of photosensitive material has been patterned in accordance with one embodiment of the present claimed invention.

FIG. 2S is a side sectional view of the structure of FIG. 2R wherein the pixel metal layer (comprised of Ti/TiN/AlCu/TEOS) has been patterned in accordance with one embodiment of the present claimed invention.

FIG. 2T is a side sectional view of the structure of FIG. 2S wherein the remaining portions of the layer of photosensitive material have been removed in accordance with one embodiment of the present claimed invention.

FIG. 2U is a side sectional view of the structure of FIG. 2T wherein a composite passivation layer (NON) has been deposited thereover in accordance with one embodiment of the present claimed invention.

FIG. 3 is a flow chart of steps performed in accordance with one embodiment of the present claimed invention.

The drawings referred to in this description should be understood as not being drawn to scale except if specifically noted.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

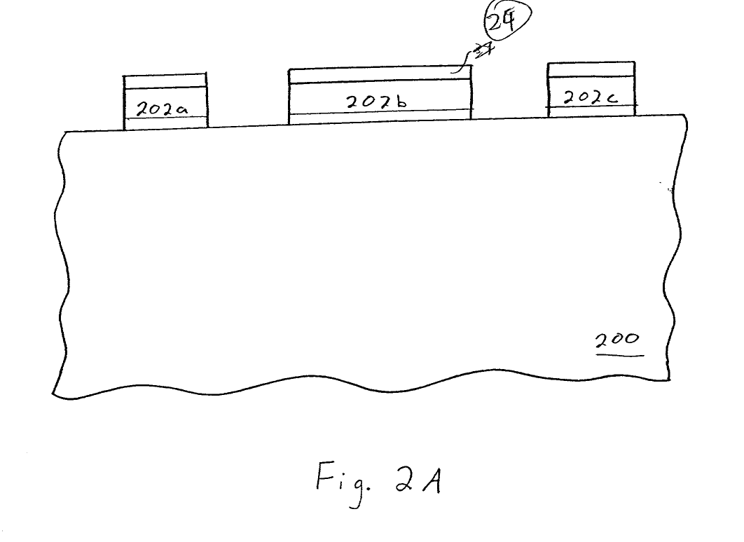

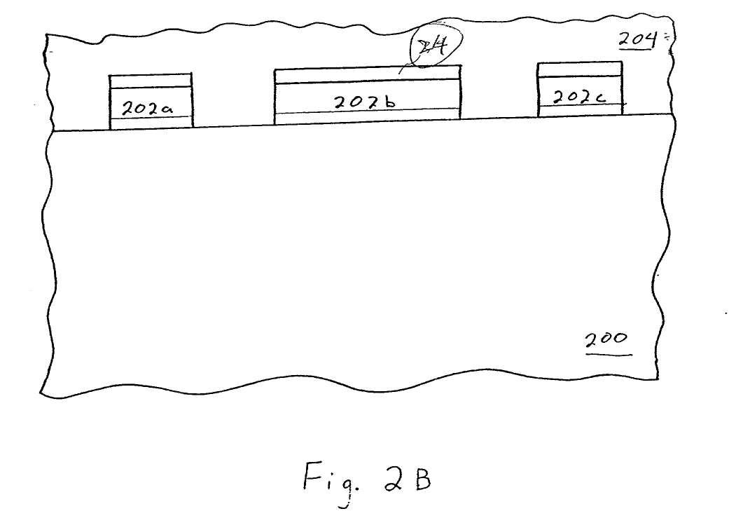

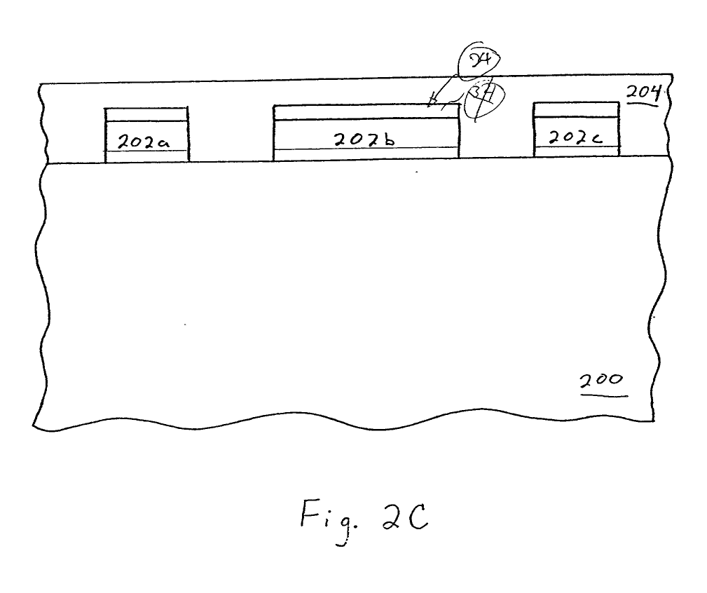

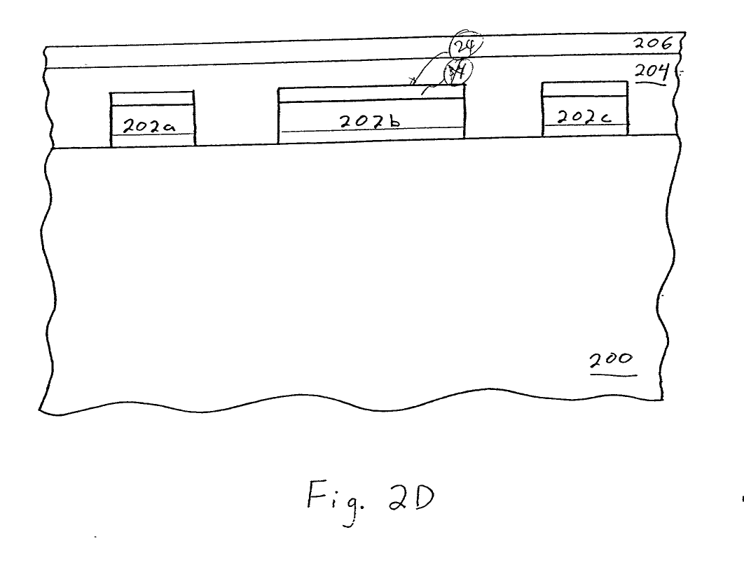

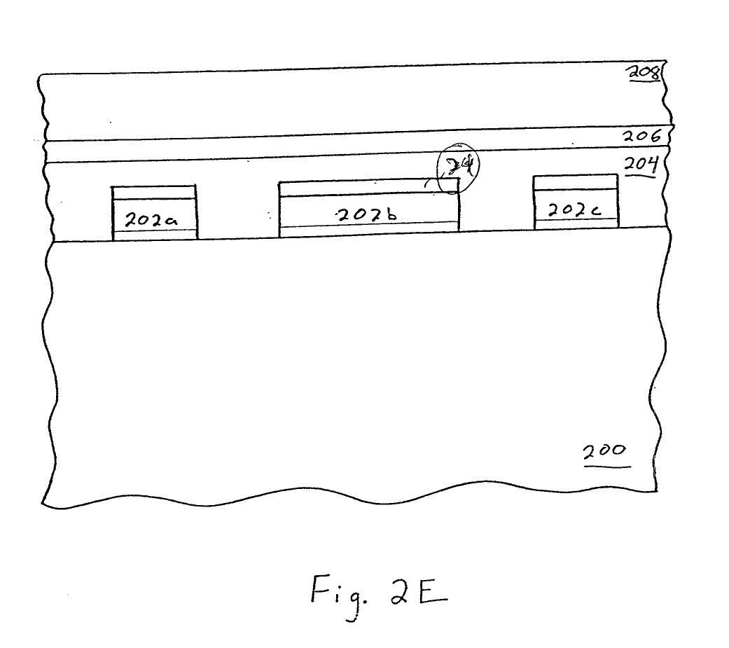

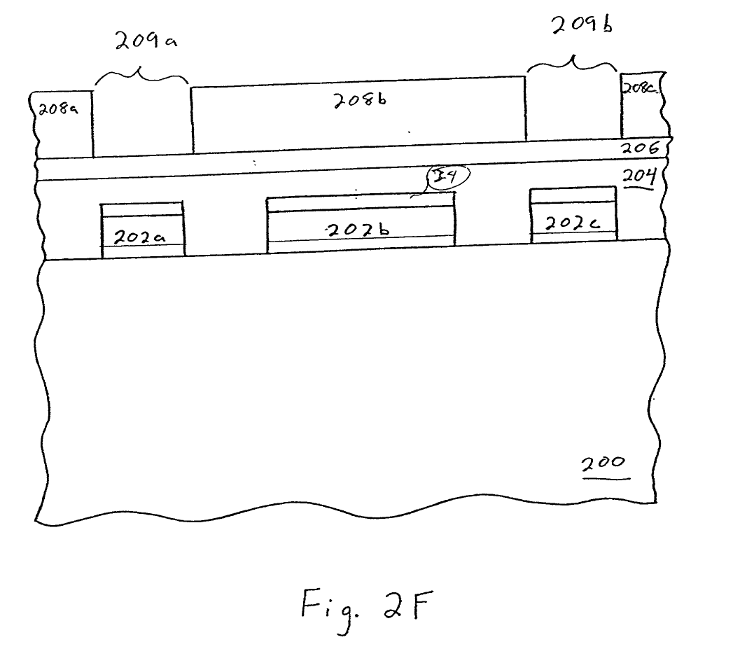

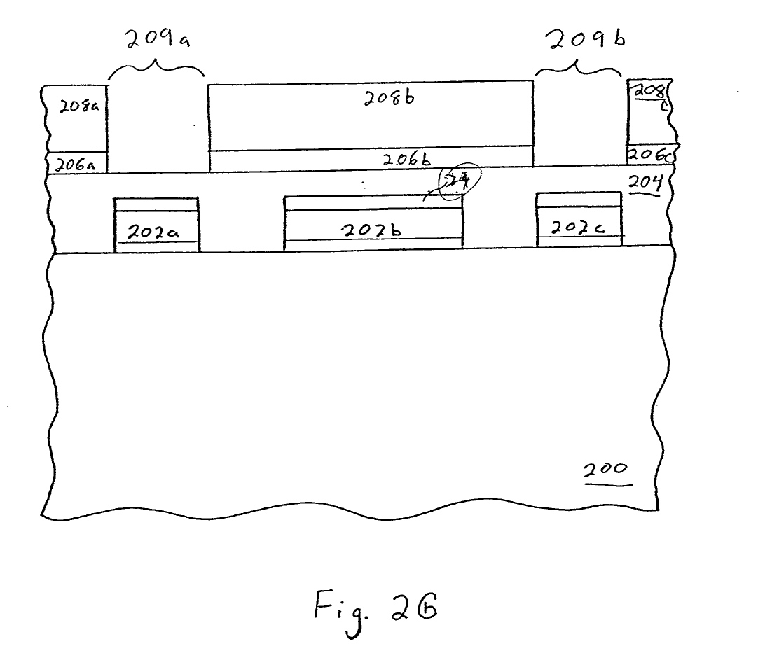

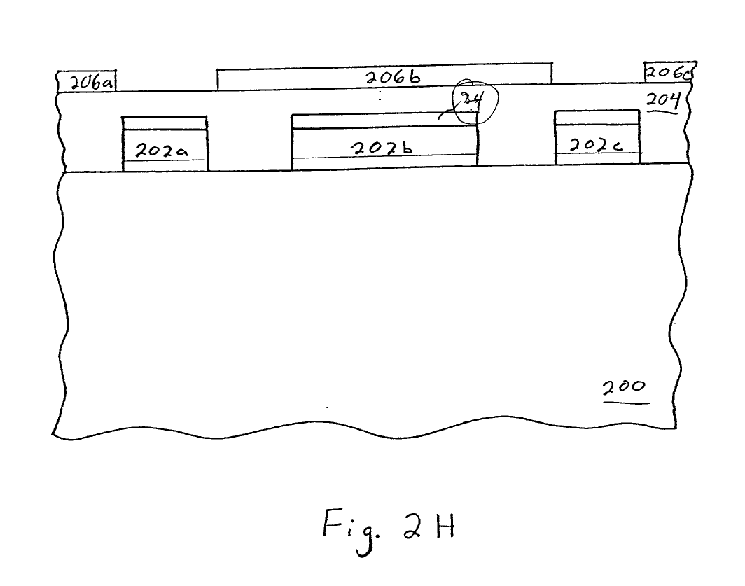

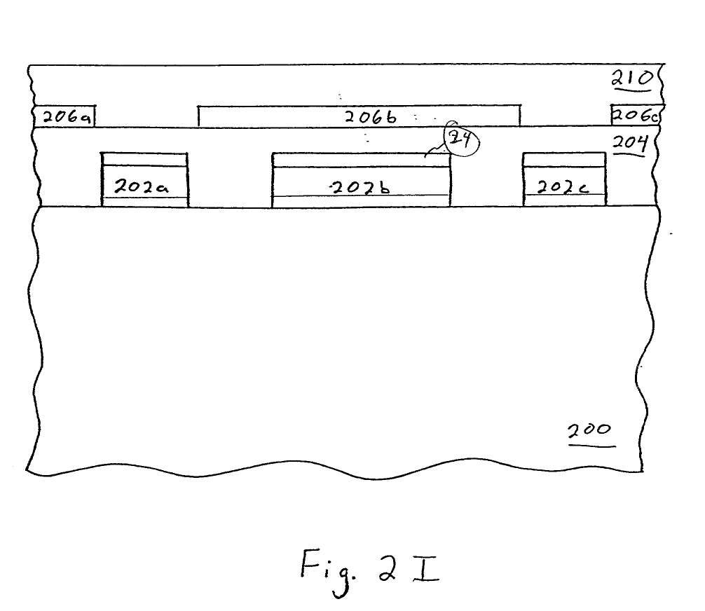

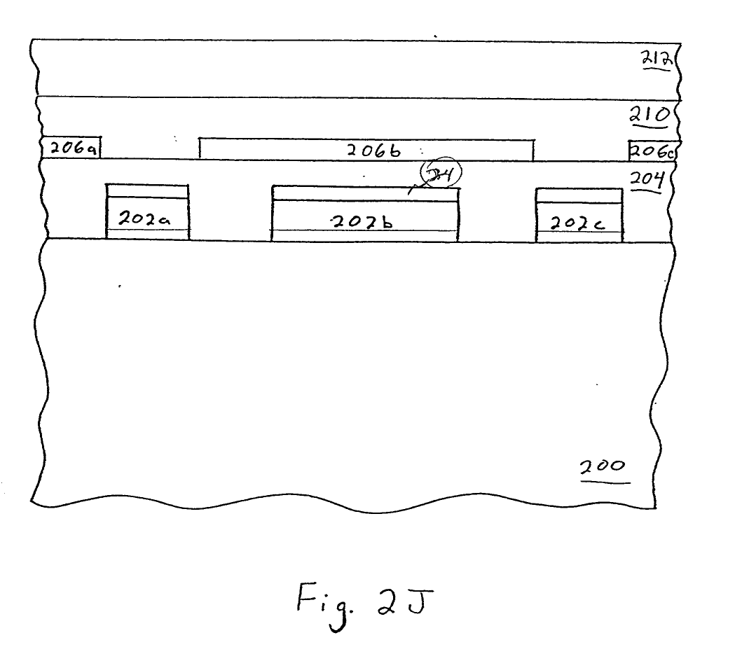

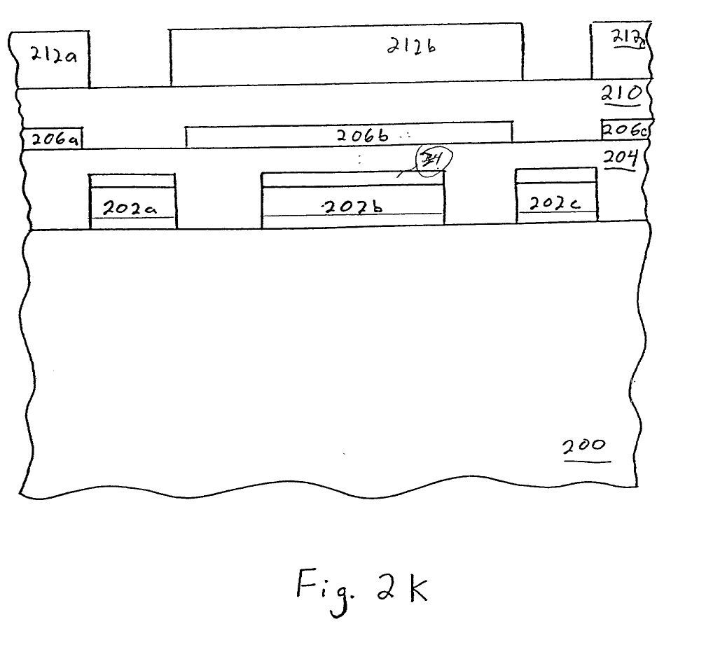

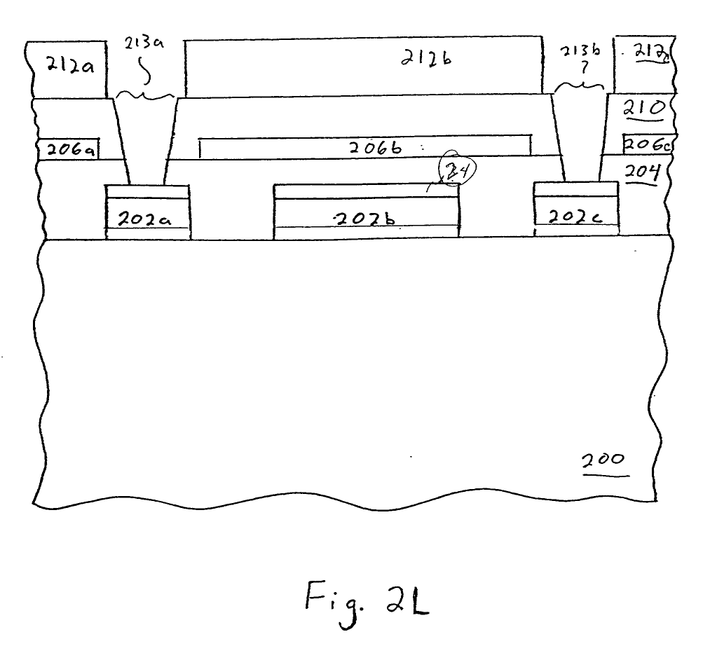

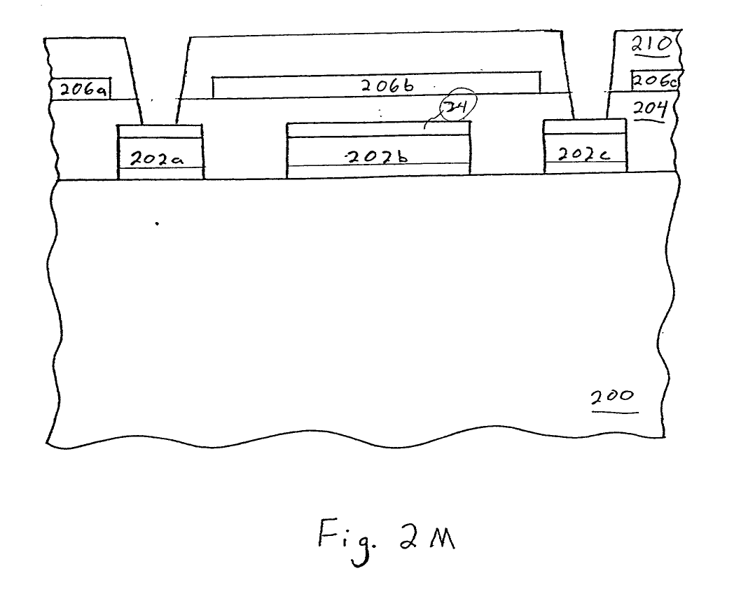

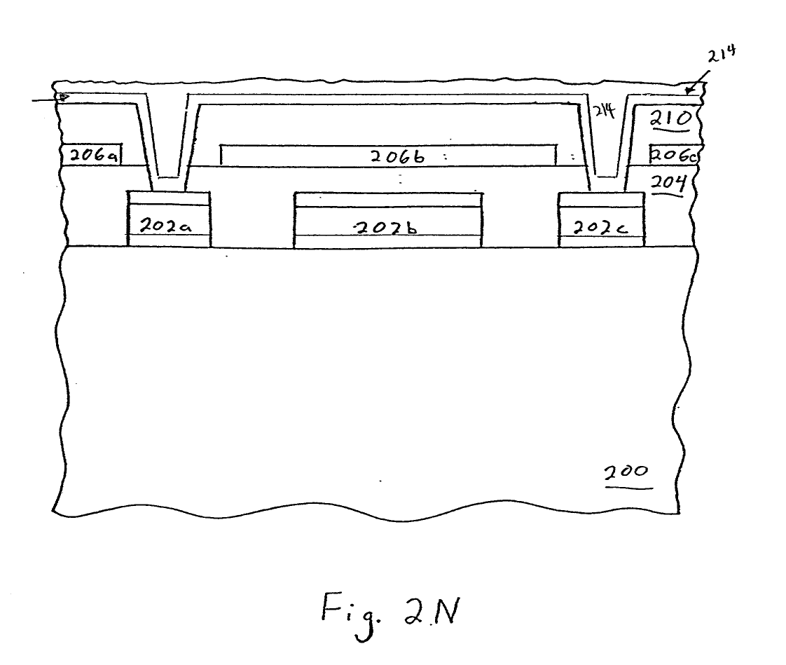

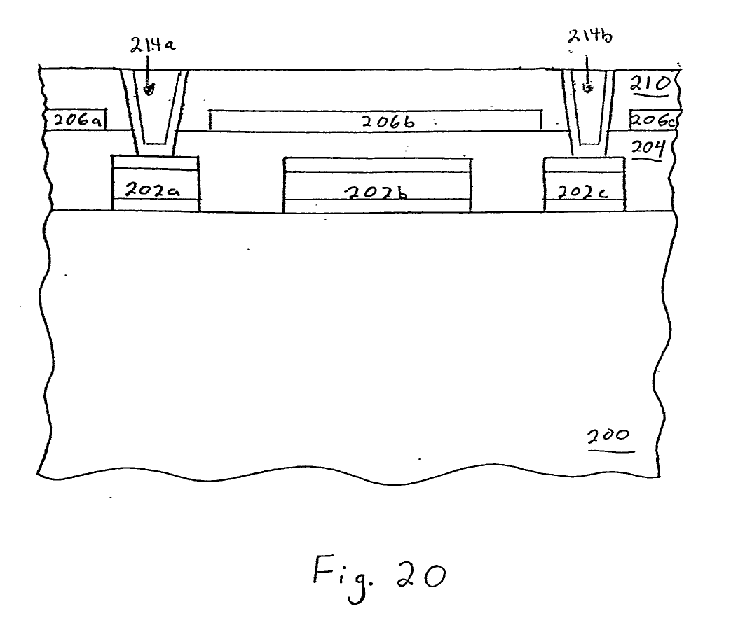

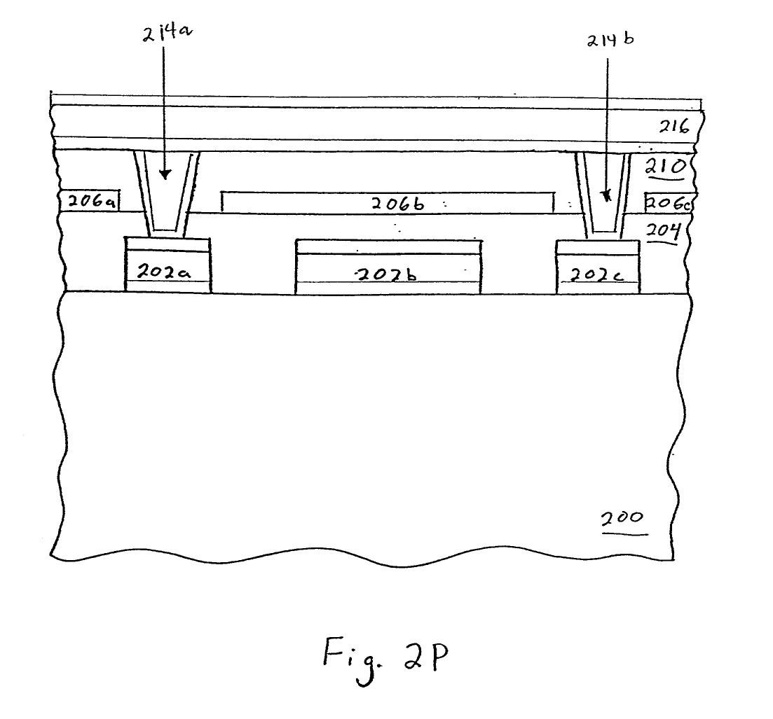

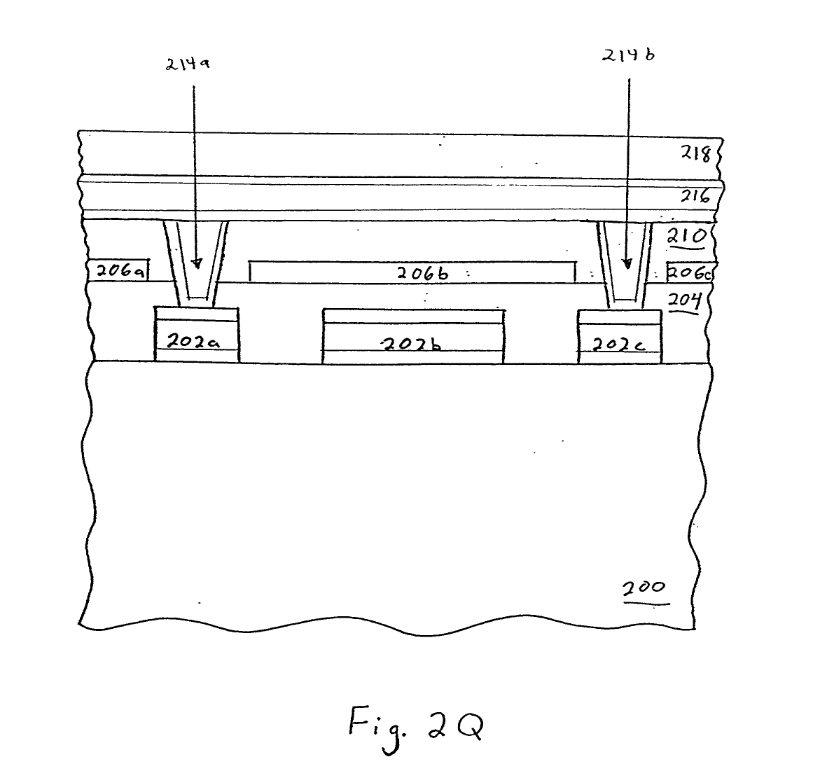

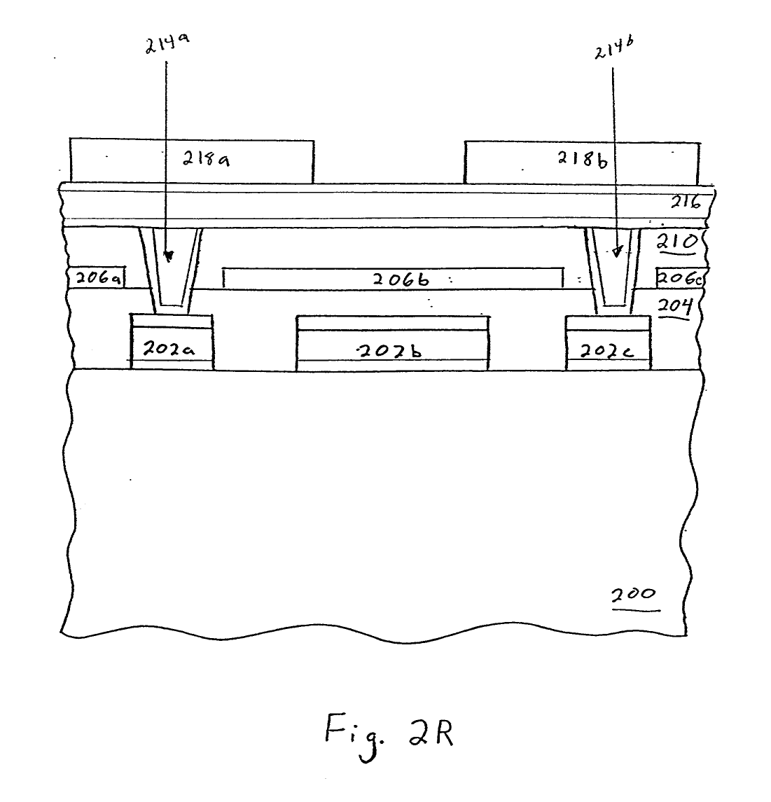

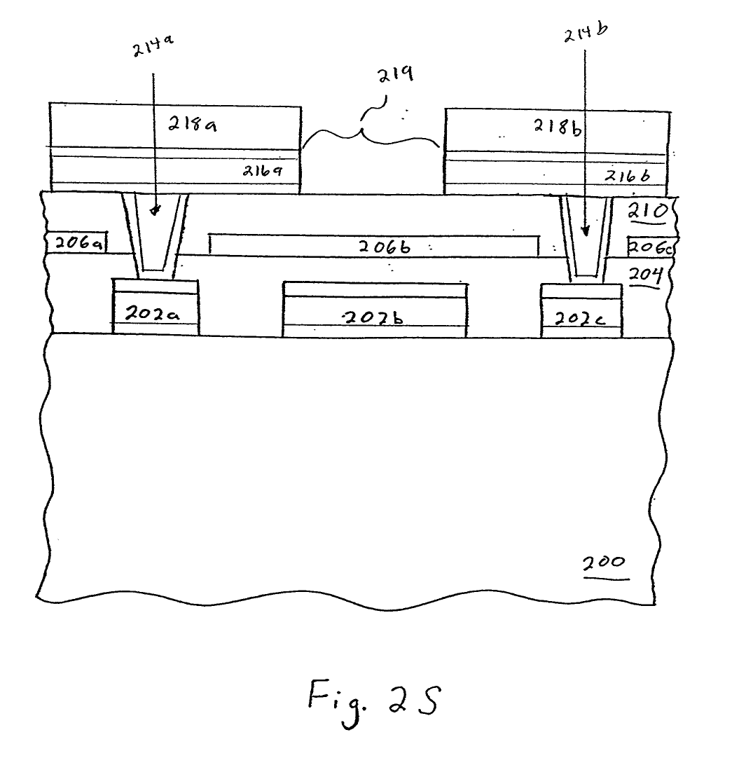

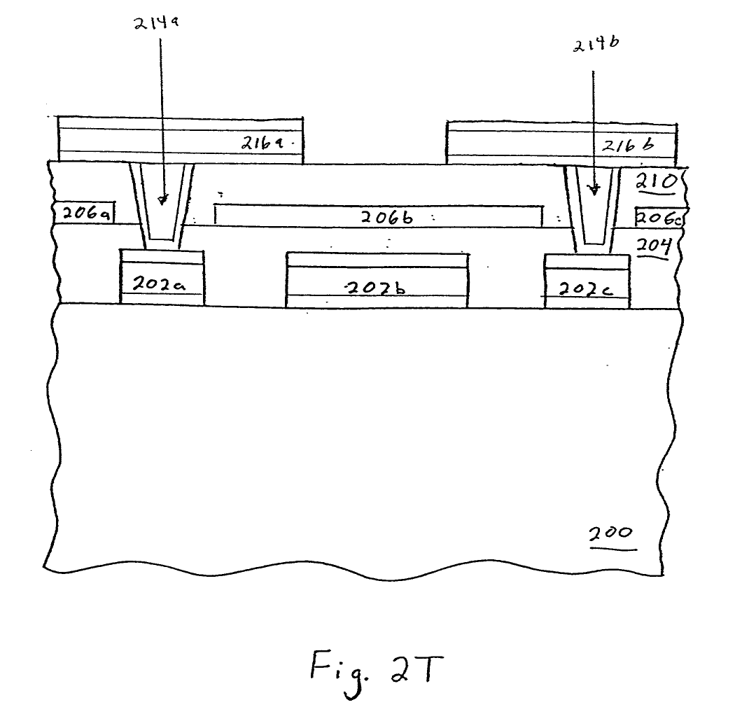

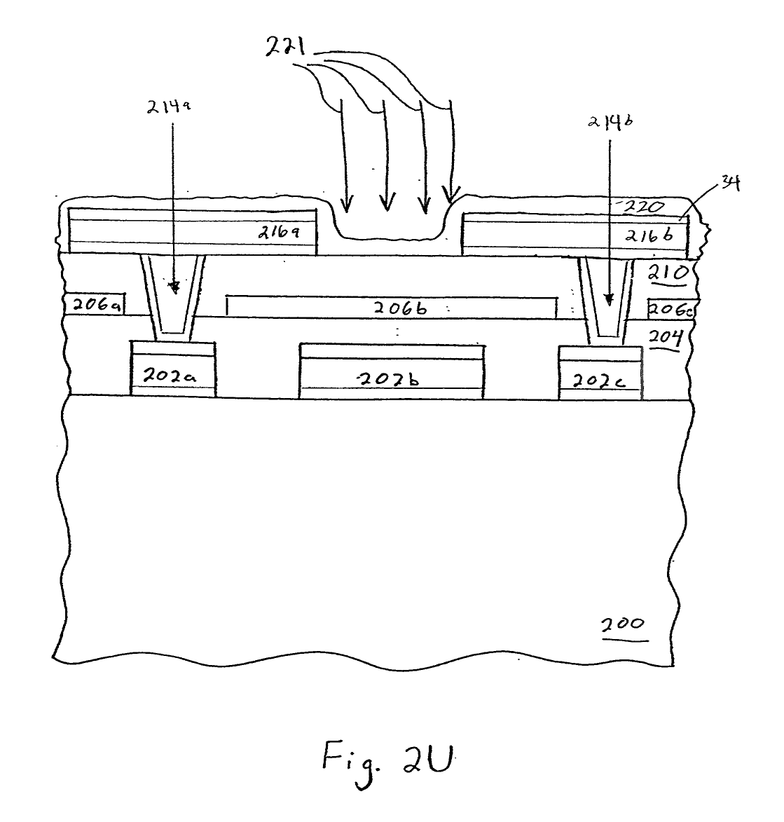

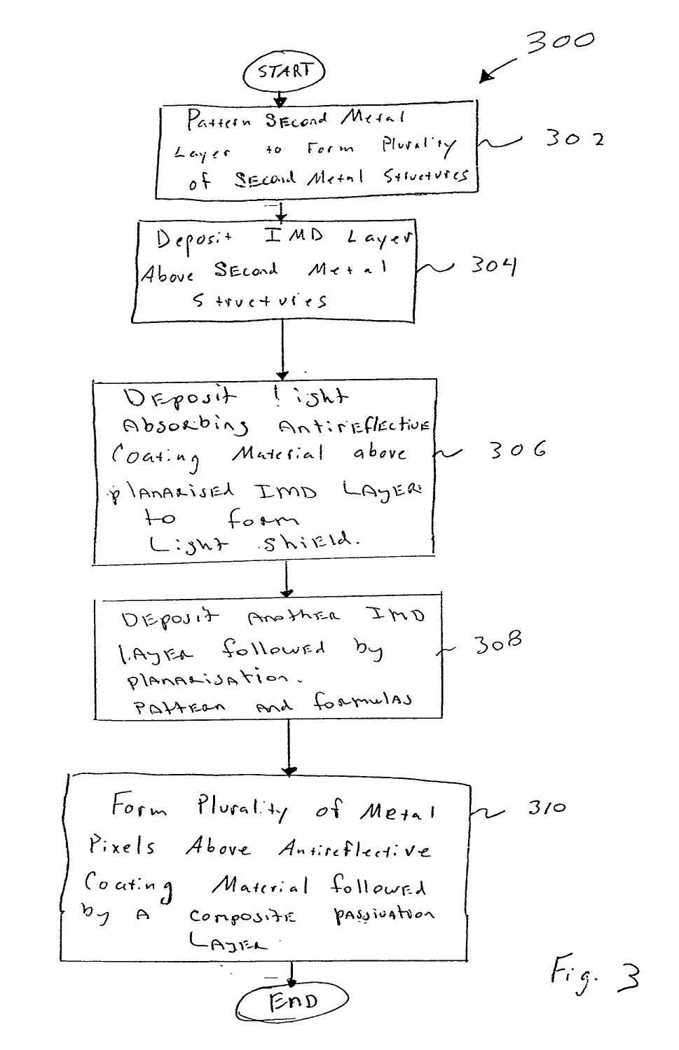

FIGS. 2A-2U provide side sectional views of the structure created according to embodiments of the method of the present invention as set forth in the flow chart of FIG. 3. For purposes of clarity, the following discussion will utilize the side sectional views of FIGS. 2A-2U in conjunction with the flow chart of FIG. 3 to clearly describe the embodiments of the present invention. As will be described in detail below, the present embodiments provide a light shield structure for reducing the transmission of incident light through a gap region located between adjacent ones of a plurality of top metal pixels such that transmission of incident light through the gap region towards underlying active devices is reduced.

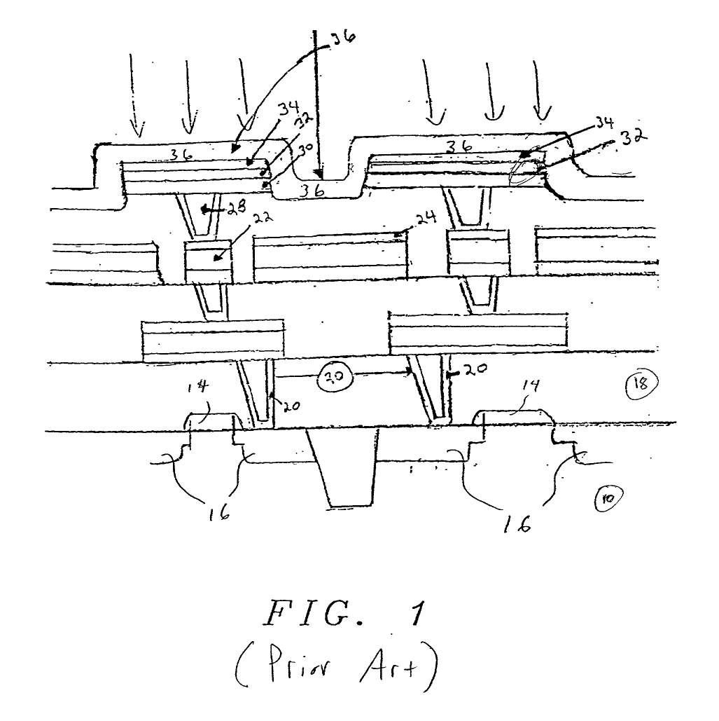

First, referring briefly to Prior Art FIG. 1 for background information, a side sectional view of a portion of a conventional CMOS backplane structure for a microdisplay is shown. The structure of Prior Art FIG. 1 is presented here for purposes of illustration of the elements of certain conventional display devices. The embodiments of the present invention are not limited to use solely with such a structure and such elements. Specifically, the embodiments of the present invention are well suited to use with display device structures: which are comprised of a lessor or greater number of metal layers; which contain additional elements; or which contain fewer elements. Furthermore, although portions of the following discussion may specifically recite the use of various embodiments of the present invention in conjunction with a microdisplay, the present invention is well suited to use with various types of display devices other than microdisplays. Referring again to Prior Art FIG. 1, there is shown a semiconductor substrate 10, preferably composed of monocrystalline silicon. Semiconductor device structures which may include polysilicon gate electrodes 14 and source and drain regions 16 are shown which in combination comprise the active devices of the display device. An insulating layer 18 is formed overlying the semiconductor device structures. Between the polysilicon gate electrodes and the top mirror layer, there can be one or more (up to five) metal layers for interconnection purposes having intermetal dielectric layers therebetween.

A barrier/glue layer 20, comprising titanium/titanium nitride is deposited over a contact hole and tungsten (W) is deposited and etched back or polished away so that a W plug is formed. Another barrier/glue material such as Ti/TiN, is then deposited before a layer of conducting material, such as aluminum or an aluminum alloy, is deposited over the barrier/glue layer and patterned to form metal lines 22. An anti-reflective coating (ARC) layer 24 may be deposited over the metal layer before patterning. An insulating layer 26, such as silicon dioxide, undoped silicate glass (USG), a tetraethoxysilane (TEOS) oxide, or the like, is deposited over the metal lines. Openings are etched through the insulating layer 26 to the metal lines, and a barrier material is deposited into the via opening. A tungsten layer is deposited over the insulating layer and within the opening and then etched back to form tungsten plugs 28. Another barrier layer and metal layer is deposited over the insulating layer 26. The top metal layer is typically aluminum or an aluminum alloy, such as AlCu or AlCuSi, with a TEOS hardmask layer 34.

With reference still to Prior Art FIG. 1, composite passivation layer 36 of an oxide/nitride stack oxide (can be as many as six layers) is deposited over the top metal pixel layer, optimized for reflectance. In one embodiment, the oxide/nitride stack is comprised of oxide (O), or oxide/nitride (ON), or oxide/nitride/oxide (ONO). In another embodiment, the oxide/nitride stack is comprised of nitride (N), or nitride/oxide (NO), nitride/oxide/nitride (NON). In one embodiment, the O, ON, ONO, N, NO, or NON layers will have a total thickness of between about 500 and 4,000 Angstroms. The thinner top metal stack (approximately 2000-3000 Angstroms) including the TEOS cap is patterned to form the reflective metal pixels 32. As mentioned above, the structure of Prior Art FIG. 1 is presented here for purposes of illustration of certain conventional display device characteristics, and the embodiments of the present invention are not limited solely to use with a display device having precisely the same structure and elements shown in Prior Art FIG. 1.

With reference now to FIG. 2A, a side sectional view of a portion of a backplane of an LCD structure is shown. The structure of FIG. 2A shows a plurality of metal structures 202a, 202b, 202c, formed above a substrate. For purposes of clarity, many of the underlying elements (such as, for example, those shown in FIG. 1) are not shown in FIG. 2A. Furthermore, although not shown in FIG. 2A or subsequent Figures, for purposes of clarity, it will be understood that the subsequently formed metal pixels will be electrically coupled to underlying structures which extend into substrate 200 (e.g. active devices 14). Additionally, the present embodiment is well suited to use with a plurality of metal pixels which are formed at a metal layer other than the metal layer shown in the present Figures. That is, the present embodiments are not limited to use with metal pixels formed using a specific one of the many metal layers used in the formation of conventional LCD devices. Also, although only two metal pixels 216a and 216b will be shown in FIG. 2U, for example, it will be understood that such a limited number of metal pixels is shown for purposes of clarity.

Referring still to FIG. 2A, as will be discussed in detail below, in conventional LCD backplane structures, incident light may pass between metal structures 202a, 202b, and 202c and ultimately impinge underlying active devices (e.g. active devices 14 of FIG. 1). Such impingement by incident light poses a threat to device operation due to photoelectron generation/interference. As will be discussed below, the present invention provides a solution to the aforementioned problem.

With reference still to FIG. 2A, and now also to step 302 of FIG. 3, the present embodiment performs the step of patterning a second metal layer to form a plurality of second metal structures typically shown as 202a, 202b, and 202c.

At step 304, and as shown in FIG. 2B, the present embodiment then deposits an intermetal dielectric layer 204 above the plurality of second metal structures 202a, 202b, and 202c. In one embodiment, intermetal dielectric layer 204 is comprised of a non-conductive material such as, for example, tetraethoxysilane (TEOS), high density plasma deposited oxide (HDP), and the like. In the present embodiment, layer of dielectric material 204 provides an insulating barrier between a subsequently deposited material which can be conductive (to be discussed in detail below) and electrically conductive elements such as, for example, metal structures 202a, 202b, and 202c.

Referring now to FIG. 2C, in one embodiment of the present invention, intermetal dielectric layer 204 is subjected to a planarization process. In one embodiment, a chemical mechanical polishing (CMP) process is used to perform the planarization process. Although such a planarization process is used in on embodiment, the present invention is also well suited to an embodiment in which intermetal dielectric layer 204 is planarized using a method other than CMP.

With reference now to FIG. 2D, and to step 306 of FIG. 3, the present embodiment then deposits a light absorbing antireflective coating material 206 above intermetal dielectric layer 204 to form a light shield such that transmission of incident light towards underlying active devices is reduced. More specifically, in one embodiment, antireflective coating material 206 is deposited to a thickness on the order of a few to several thousand Angstroms. Although such a thickness is recited for antireflective coating material 206 in the present embodiment, the present invention is well suited to the use with an antireflective coating material which is deposited to a greater or lesser depth. Furthermore, in one embodiment, antireflective coating material 206 is comprised of an organic antireflective coating material such as, for example, organic BARC. In yet another embodiment, antireflective coating material 208 is comprised of an inorganic antireflective coating material such as, for example, TiN or SiON. Although such materials are recited in the present embodiment, the present embodiment is well suited to the use of various other antireflective coating materials.

Referring still to step 306 and now to FIGS. 2E, 2F, and 2G in one embodiment of the present invention, a layer of photosensitive material 208 such as, for example, photoresist is deposited above antireflective coating material 206. As shown in FIG. 2F, layer of photosensitive material 208 is then patterned to form a mask (see e.g. regions 208a, 200b, and 208c) for the underlying antireflective coating material 206. That is, layer of photosensitive material 208 is removed from regions 209a and 209b of FIG. 2G.

Referring still to step 306 and to FIG. 2G, using the via mask formed by regions 208a, 200b, and 208c of layer of photosensitive material 208, the present embodiment substantially removes portions of layer of antireflective coating material 206 from above at least a portion of intermetal dielectric layer such that portions of antireflective coating material (see e.g. regions 206a 206b, and 206c) remain above intermetal dielectric layer 204. That is, those portions of the layer of antireflective coating material 206 which were not covered by photosensitive material 208 are removed. Remaining portions 206a, 206b, and 206c of the antireflective coating material serve as a barrier to incident light. Thus, as will be described and illustrated in further detail below, remaining portions 206a, 206b, and 206c of the light absorbing antireflective coating material reduce the transmission of incident light towards, for example, active devices 14 of FIG. 1. As a result, the present invention reduces impingement by incident light and alleviates the threat to device operation caused by photoelectron generation/interference.

Referring still to step 306 and now to FIG. 2H, remaining portions 206a, 206b, and 206c of the layer of antireflective coating material are shown after remaining portions 208a, 200b, and 208c of the layer of photosensitive material have been removed therefrom.

With reference now to step 308, and as shown in FIG. 2I, the present embodiment then deposits another intermetal dielectric layer 210 above remaining portions 206a, 206b, and 206c of the layer of antireflective coating material. In one embodiment, intermetal dielectric layer 210 is comprised of a non-conductive material such as, for example, tetraethoxysilane (TEOS), high density plasma deposited oxide (HDP), and the like. In one embodiment of the present invention, intermetal dielectric layer 210 is subjected to a planarization process. In one embodiment, a chemical mechanical polishing (CMP) process is used to perform the planarization process. Although such a planarization process is used in on embodiment, the present invention is also well suited to an embodiment in which intermetal dielectric layer 210 is planarized using a method other than CMP.

Referring still to step 308 and now to FIGS. 2J and 2K in one embodiment of the present invention, a layer of photosensitive material 212 such as, for example, photoresist is deposited above intermetal dielectric layer 210. As shown in FIG. 2K, layer of photosensitive material 212 is then patterned to form a via mask (see e.g. regions 212a, 212b, and 212c) for the underlying intermetal dielectric layer 210.

Referring still to step 308 and to FIG. 2L, using the mask formed by regions 212a, 212b, and 212c of layer of photosensitive material 212, the present embodiment forms vias 213a and 213b. As shown in FIG. 2L, in the present embodiment, vias 213a and 213b extend through intermetal dielectric layer 210, between remaining portions 206a, 206b, and 206c of the antireflective coating material, and through intermetal dielectric layer 204 to metal structures 202a and 202c.

Referring still to step 308 and now to FIG. 2M, remaining portions of the intermetal dielectric layer 210 are shown after remaining portions 212a, 212b, and 212c of the layer of photosensitive material have been removed therefrom.

Referring now to FIGS. 2N and 2O, in one embodiment of the present invention, a layer of barrier metal (e.g. Ti/TiN) followed by a a conductive material 214 (e.g. W) is deposited above intermetal dielectric layer 210 and into vias 214a and 214b. In one embodiment of the present invention, the layer of conductive material is comprised of tungsten. Although such a material is recited in the present embodiment, the present invention is also well suited the use of various other materials to fill vias 214a and 214b. As shown in FIG. 20, the present embodiment then removes the layer of conductive material from substantially everywhere except within vias 214a and 214b.

Referring now to step 310, and to step 2P, the present embodiment then recites forming a plurality of top metal pixels above antireflective coating material 206a, 206b, and 206c wherein adjacent ones of the plurality of metal pixels have a gap region disposed therebetween. More specifically, in one embodiment of the present invention, the present embodiment deposits a top metal pixel layer 216 (comprising of a Ti/TiN/AlCu/TEOS hardmask) above intermetal dielectric layer 210 and filled vias 214a and 214b.

Referring still to step 310 and now to FIGS. 2Q and 2R in one embodiment of the present invention, a layer of photosensitive material 218 such as, for example, photoresist is deposited above metal layer 216. As shown in FIG. 2R, layer of photosensitive material 218 is then patterned to form a mask (see e.g. regions 218a and 218b) for metal layer 216.

Referring still to step 310 and to FIG. 2S, using the mask formed by regions 218a and 218b of layer of photosensitive material 218, the present embodiment removes exposed portions of exposed metal layer 216 to ultimately form metal pixels 216a and 216b. In FIG. 2S, a gap region 219 is shown formed between metal pixels 216a and 216b. As shown in FIG. 2S, in the present embodiment, the plurality of metal pixels 216a and 216b are formed above intermetal dielectric layer 210 with gap region 219 disposed above antireflective coating material 206. More specifically, in the present embodiment, gap region 219 is formed above remaining portion 206b of the antireflective coating material.

Referring still to step 308 and now to FIG. 2T, metal pixels 216a and 216b are shown after remaining portions 218a and 218b of the layer of photosensitive material have been removed therefrom.

Referring still to step 310 and now to FIG. 2U, the present invention then deposits a thin composite passivation layer 220 above the structure of FIG. 2T. In one embodiment, composite passivation layer 220 is comprised, for example, of a nitride (N), nitride/oxide (NO), or nitride/oxide/nitride (NON) layer or the like (can be as many as six layers), optimized for reflectance. This together with layer 34 (TEOS and cap) will form an optical interface and passivation layer on the reflective metal pixel. In one embodiment, this N, NO, or NON or the like layer will have a total thickness of between about 500 and 4,000 Angstroms. Although such materials and thicknesses are recited in the present embodiment, the present embodiment is well suited to the use of various other materials having various other respective thicknesses. Importantly, the present invention reduces the penetration of ambient light into the backplane.

With reference still to FIG. 2U, as mentioned above, in the present embodiment, gap region 219 is formed above remaining portion 206b of the antireflective coating material. In so doing, incident light, typically shown by arrows 221, is prevented by portion 206b of antireflective coating material 206 from passing unimpeded towards underlying active devices. That is, the present embodiment reduces the transmission of incident light, which passes through gap region 219, towards underlying active devices.

Thus, the present invention provides a display device formation method and apparatus which reduces the penetration of incident light into the backplane.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A method of forming a light shield for a microdisplay backplane, said method comprising the steps of:
a) patterning a second metal layer to form a plurality of second metal structures;
b) depositing an intermetal dielectric layer above said plurality of second metal structures;
c) depositing a light absorbing antireflective coating material above said intermetal dielectric layer to form a light shield such that transmission of incident light towards underlying active devices is reduced; and
d) forming a plurality of metal pixels above said antireflective coating material wherein adjacent ones of said plurality of metal pixels have a gap region disposed therebetween.

2. The method of forming a light shield for a microdisplay device as recited in claim 1 wherein said step c) comprises:
c1) depositing a layer of said light absorbing antireflective coating material above said plurality of first metal structures;
c2) patterning said layer of said antireflective coating material such that a plurality of regions of said antireflective coating material are formed above said intermetal dielectric layer; and
c3) depositing another layer of intermetal dielectric layer followed by planarization.

3. The method of forming a light shield for a microdisplay backplane as recited in claim 1 wherein said step d) comprises:
forming said plurality of said metal pixels above said antireflective coating material with said gap region disposed above said antireflective coating material such that said incident light passing through said gap region is prevented by said antireflective coating material from passing unimpeded towards said underlying active devices.

4. The method of forming a light shield for a microdisplay backplane as recited in claim 1 wherein said step c) comprises depositing an organic antireflective coating material above said intermetal dielectric layer.

5. The method of forming a light shield for a microdisplay backplane as recited in claim 4 wherein said step c) comprises depositing an organic antireflective coating material comprised of organic BARC above said intermetal dielectric layer.

6. The method of forming a light shield for a microdisplay backplane as recited in claim 1 wherein said step c) comprises depositing an inorganic antireflective coating material above said intermetal dielectric layer.

7. The method of forming a light shield for a microdisplay backplane as recited in claim 6 wherein said step c) comprises depositing an inorganic antireflective coating material comprised of TiN or SiON above said intermetal dielectric layer.

8. In a display device, a light shield structure for reducing the transmission of incident light through a gap region located between adjacent ones of a plurality of metal pixels and towards underlying active devices, said light shield structure comprised of:
a light absorbing antireflective coating material disposed between a previous metal layer and said plurality of top metal pixels, said antireflective coating material disposed to prevent said incident light which passes through said gap region from proceeding directly towards said underlying active devices.

9. The light shield structure for reducing the transmission of incident light through a gap region located between adjacent ones of a plurality of metal pixels of claim 8 wherein said antireflective coating material is comprised of an organic material.

10. The light shield structure for reducing the transmission of incident light through a gap region located between adjacent ones of a plurality of metal pixels of claim 8 wherein said antireflective coating material is comprised of an inorganic material.

11. The light shield structure for reducing the transmission of incident light through a gap region located between adjacent ones of a plurality of metal pixels of claim 9 wherein said antireflective coating material is comprised of organic BARC.

12. The light shield structure for reducing the transmission of incident light through a gap region located between adjacent ones of a plurality of metal pixels of claim 10 wherein said antireflective coating material is comprised of TiN or SiON.

13. A method of forming a light shield for a display device, said method comprising the steps of:
a) patterning a second metal layer to form a plurality of second metal structures;
b) depositing an intermetal dielectric layer above said plurality of second metal structures;
c) depositing a light absorbing antireflective coating material above said intermetal dielectric layer to form a light shield such that transmission of incident light towards underlying active devices is reduced, said step of depositing said antireflective coating material further comprising the steps of:
c1) depositing a layer of said antireflective coating material above said plurality of second metal structures; and
c2) patterning said layer of said antireflective coating material such that a plurality of regions of said antireflective coating material are formed above said intermetal dielectric layer followed ny another palanarized IMD layer; and
d) forming a plurality of metal pixels above said antireflective coating material wherein adjacent ones of said plurality of metal pixels have a gap region disposed therebetween, said gap region disposed above said antireflective coating material such that said incident light passing through said gap region is prevented by said antireflective coating material from passing unimpeded towards said underlying active devices.

14. The method of forming a light shield for a display device as recited in claim 13 wherein said step c) comprises depositing an organic antireflective coating material above said intermetal dielectric layer.

15. The method of forming a light shield for a display device as recited in claim 14 wherein said step c) comprises depositing an organic antireflective coating material comprised of organic BARC above said intermetal dielectric layer.

16. The method of forming a light shield for a display device as recited in claim 13 wherein said step c) comprises depositing an inorganic antireflective coating material above said intermetal dielectric layer.

17. The method of forming a light shield for a display device as recited in claim 16 wherein said step c) comprises depositing an inorganic antireflective coating material comprised of TiN or SiON above said intermetal dielectric layer.
